(19) United States
(12) Patent Application Publication
(10) Pub. No.: US 2007/0033815 A1
(43) Pub. Date: Feb. 15, 2007

(54) Adjustable can opener

(76) Inventors: William J. Lazaroff, Floral Park, NY (US); Alfred H. Raschdorf JR., Kings Park, NY (US)

Correspondence Address: Lackenbach Siegel LLP, One Chase Road, Scarsdale, NY, 10583, US

(21) Appl. No.: 11/200,222

(22) Filed: Aug. 9, 2005

(51) Int. Cl. B67B 7/70

(52) U.S. Cl. 30/416

(57) ABSTRACT

A variable-position can opener for opening cans with various-sized beads has a pair of handles on a pivot and is able to pierce a can's lid. The cutter is on the first handle of a handle pair, and a driver, on the second handle, grips the bead and moves along its periphery. When handles are gripped, the cutter and driver are brought together and apply a piercing force to the can and bead. A pair of gears, one on the cutter and one on the driver, engages cutter and driver when the handles are closed. A turner, which moves the driver and cutter along the bead, can move among a number of positions, and a cam limits the degree to which the handles can close and adjusts the cutter to a predetermined depth of lid penetration.

### BACKGROUND OF THE INVENTION

1. Field of the Invention

The present invention relates to can openers. More particularly, the present invention relates to adjustable can openers having squeeze-type action for latching onto, piercing and removing lids of several can types.

2. Description of the Prior Art

Disposable can containers of the type formed of aluminum, tin or a combination of metals typically have a cylindrical body or side, a top lid and bottom lid. The top lid has a stepped rim that forms an edge that is sealed by crimping and rolling. This stepped rim is commonly referred to as the edge or bead. Beads of most disposable can containers have a standard and consistent height.

Can openers of the hand-held type typically have a pair of pivotally connected handles. The handle pair includes a first handle having a traction or driving means and a second handle having a rotatable cutting means. In operation, mechanical pressure is generally applied by squeezing the first and second handles of the handle pair towards each other to a closed or cutting position. This squeezing action causes the driving means to forcibly engage the underside of the can bead while the rotatable cutting means pierces the top lid of the can proximal and interior to the bead. The can is moved under the cutting means by rotation of the driving means until at least one 360-degree rotation of the can is completed, in the case of a circular can, or the entire periphery of the can and the can lid can be removed from the cylindrical body.

Recent developments in disposable can technology have provided a can having a pull-tab means for lifting the lid from the cylindrical can body, thereby eliminating the need for a separate can opener. However, if a pull-tab means malfunctions, a can opener must be employed to remove the lid from the can.

Manufacture of pull-tab type cans requires an increased bead height. Due to the increased dimensions of the bead, conventional can openers do not operate effectively with cans having pull-tab means. The increased bead height of a can having pull-tab means makes it impossible to properly and securely place the can bead between the traction wheel and the cutting means. This stems from the fact that the longer bead tends to ride up and between the traction wheel and the cutting means so that the cutting means cannot fully and effectively pierce the top of the can.

Therefore, a need exists for a variable position can opener that successfully functions to open cans having varying bead heights such as a conventional can and a can having a pull-tab means.

### SUMMARY OF THE INVENTION

It is an object of the present invention to provide a pre-calibrated, adjustable can opener.

It is another object of the present invention to provide a can opener that may be adjusted to fit the bead of a conventional can.

It is yet another object of the present invention to provide a can opener that may be adjusted to fit the bead of a pull-tab type can.

It is still another object of the present invention to provide a can opener that may be adjusted to fit a plurality of cans having varying predetermined bead heights.

It is still a further object of the present invention to provide a can opener having a spacer means for manually and selectively adjusting the can opener between a plurality of can opening positions.

It is a still further object of the present invention to provide a can opener having a spacer means for selectively adjusting a cutting means to accommodate a plurality of predetermined bead heights.

It is a yet further object of the present invention to provide a can opener with a spacer means that has a lower cam surface and an upper cam surface, wherein the selective interaction of each cam surface with a cam edge of the traction support provides a means for selectively controlling the degree to which the traction assembly can interact with a cutting means assembly.

These and other objects and advantages of the present invention are achieved by a variable position hand-held can opener adapted to open cylindrical can containers having beads of varying sizes comprising the following components: A pair of handle assemblies connected about a pivot point; a cutting means for piercing the lid of a can having a bead, this cutting means being coupled to a first handle of the handle assembly pair; a driving means for gripping the bead of said can and moving along a periphery of the can, this driving means being coupled to a second handle of the handle assembly pair such that when the pair of handle assemblies are gripped together said cutting means and the driving means are correspondingly brought together for applying a piercing force to said can proximate to the bead. The variable position hand-held can opener is further comprised of a gear pair, with a first gear coupled to said cutting means and a second gear coupled to said driving means. This gear pair is adapted to engage the cutting means and the driving means when the pair of handle assemblies are in the closed position. There is also a turning means coupled to the driving means for moving the driving means and the cutting means along the bead of said can; and a cam means selectively movable between a plurality of predetermined positions for limiting the degree to which the pair of handle assemblies can be moved towards each other, so that the cam means is adapted to adjust the cutting means to a pre-determined depth of penetration through a lid with respect to the container bead.

### BRIEF DESCRIPTION OF THE DRAWINGS

The foregoing and still other objects and advantages of the present invention will be more apparent from the following detailed explanation of the preferred embodiments of the invention in connection with the accompanying drawings.

FIG. 1 is a perspective view of the can opener of the present invention;

FIG. 2 is an exploded perspective view of the can opener of the present invention;

FIG. 3 is a close-up side view of the traction support and spacer means of the can opener of the present invention illustrating the spacer means in a second position and in a first position shown in phantom;

FIG. 4 is a side view of a standard can and the can opener of the present invention;

FIG. 5 is a side view of a pull-tab type can and the can opener of the present invention;

FIG. 6 is a top view of the cutting means support of the can opener of the present invention showing the slider assembly opening, and

FIG. 7 is a side view of the can opener of the present invention.

### DETAILED DESCRIPTION OF THE PREFERRED EMBODIMENTS

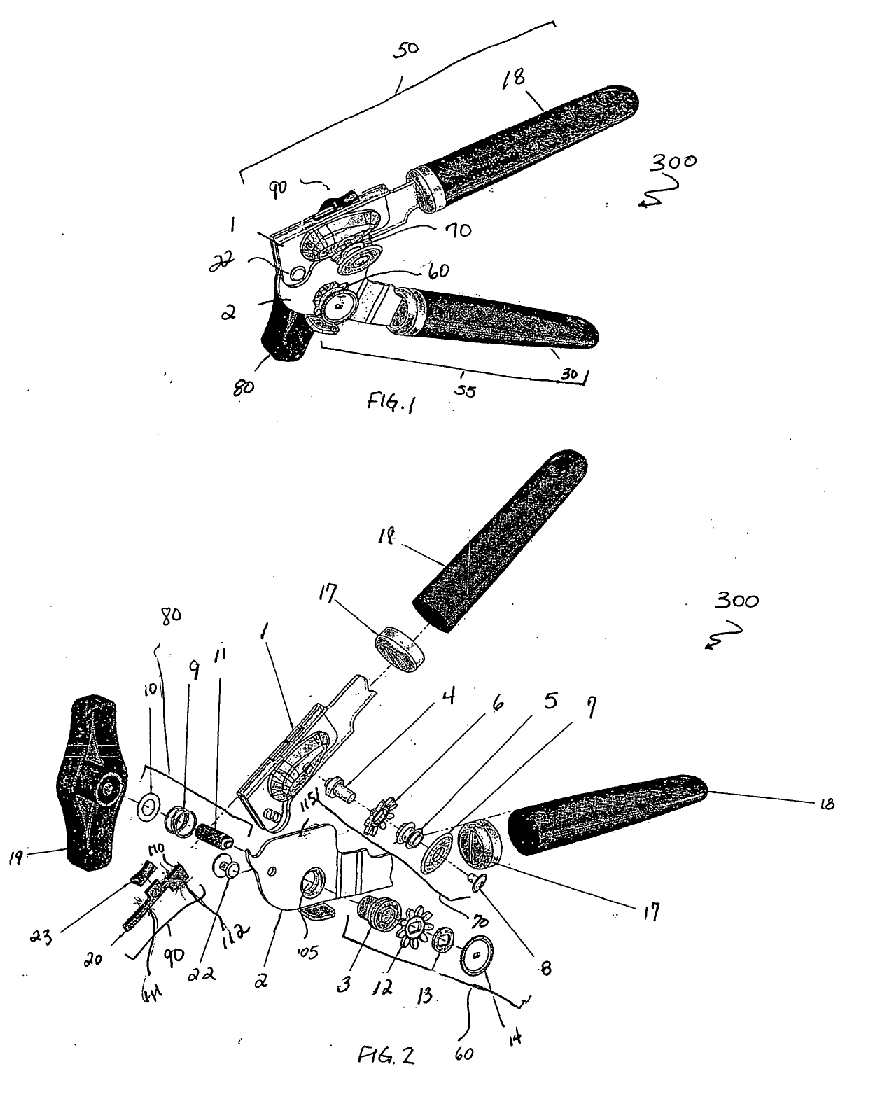

Referring to the drawings and, in particular, to FIG. 1, an adjustable can opener according to the present invention is illustrated, one generally represented by reference numeral 300. Can opener 300 preferably has a pair of pivotally mounted handle assemblies 50 and 55. Handle assembly 50 has a handle 18, a cutting means support 1 and a cutting means assembly 70. Handle assembly 55 has a handle 30, a traction support 2 and a traction assembly 60. Handle assembly 50 is preferably coupled to handle assembly 55 by a rivet 22 or any similar coupling means that allows for squeeze-type action of the handles. Can opener 300 preferably also has a rotatable turning means assembly 80, and a slider assembly 90.

Handle assemblies 50 and 55 are pivotally connected at one end and adapted to be gripped by a user at an opposite end. Traction assembly 60 and cutting assembly 70 are preferably equidistantly spaced from the pivot point and are disposed in different planes so that when handle assemblies 50 and 55 are moved toward a closed position, traction assembly 60 and cutting assembly 70 can be brought into an overlapping configuration.

As illustrated in FIG. 2, cutting means assembly 70 is coupled to cutting means support 1. Cutting means assembly 70 preferably has a post 4, a gear 6 of the conventional serrated periphery type, a spacer means 5, and a cutting means 7. In a preferred embodiment, the cutting means is a cutting wheel. However, any cutting means known in the art may be employed, such as a station cutting knife. The cutting means assembly 70 is coupled to the cutting means support 1 of handle assembly 50 by a screw 8 or any similar means for coupling gear 6, spacer means 5, and cutting means 7 to cutting means support 1. Cutting means 7 is preferably freely mounted on post 4, which is fixed to cutting means support 1 of handle assembly 50.

Traction assembly 60 is coupled to traction support 2. Traction support 2 preferably has an opening 105 for receiving at least a portion of traction assembly 60. Traction assembly 60 preferably has a driving means 14, a spacer 13, a gear 12 of the conventional serrated periphery type, and a collar 3. Driving means 14 is preferably a wheel, but may be any means commonly employed in the art.

Rotatable turning means assembly 80 is coupled to traction support 2 on a side opposite to traction assembly 60. Rotatable turning means assembly 80 preferably has a turning means 19, a spacer 10, a spring 9, and a post 11. Turning means 19 may be a knob, a wheel, a latch or any other suitable means.

Traction assembly 60 is coupled to rotating turning means assembly 80. Driving wheel 14 and gear 12 of traction assembly 60 are coupled to post 11 of rotatable turning means assembly 80, which is pivotally retained in an opening 105 of hand assembly 55 by collar 3. Spacer 10 preferably positions driving means 14 relative to hand assembly 55. As turning means 19 is rotated, post 11 turns driving means 14 together with gear 12 to propel the can opener 300 forward along a can bead.

In a preferred embodiment, hand assembly 50 has, in addition, a decorative cap 17 disposed at the coupling of cutting means support 1 to handle 18. Similarly, in this embodiment, hand assembly 55 also has a decorative cap 17 disposed at the coupling of traction support 2 to handle 30.

Squeezing or pivoting of handle assemblies 50 and 55 towards one another positions cutting means 7 in a cutting position adjacent to driving means 14 and provides considerable leverage to cutting means 7. Thus, when handle assemblies 50 and 55 are positioned on opposite sides of a bead, piercing of a can lid by cutting means 7 is facilitated. Pivoting handle assemblies 50 and 55 towards one another further provides a gripping force for securing driving means 14 against the rim of the can. The bead is held fast between gears 6 and 12 and driving means 14. The rotation of turning means 19 turns driving means 14, thereby advancing driving means 14 and gear 12 along the bead. As gear 6 of the cutting means assembly 70 engages gear 12 of traction assembly 60, the cutting means 7 is also advanced along the bead.

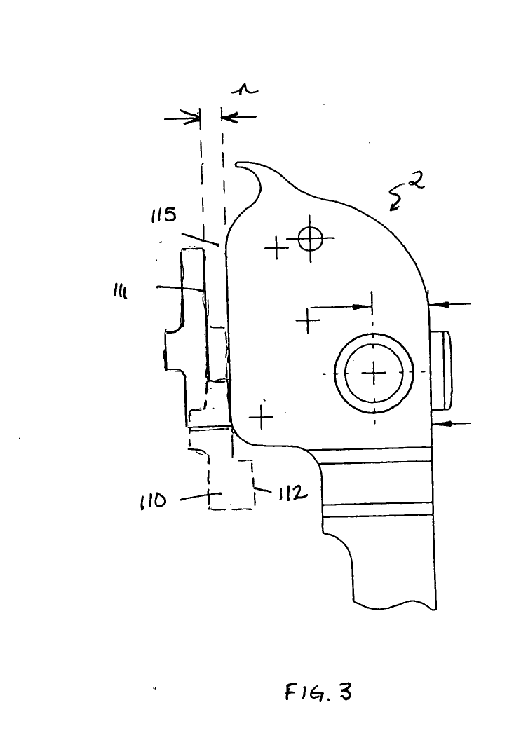

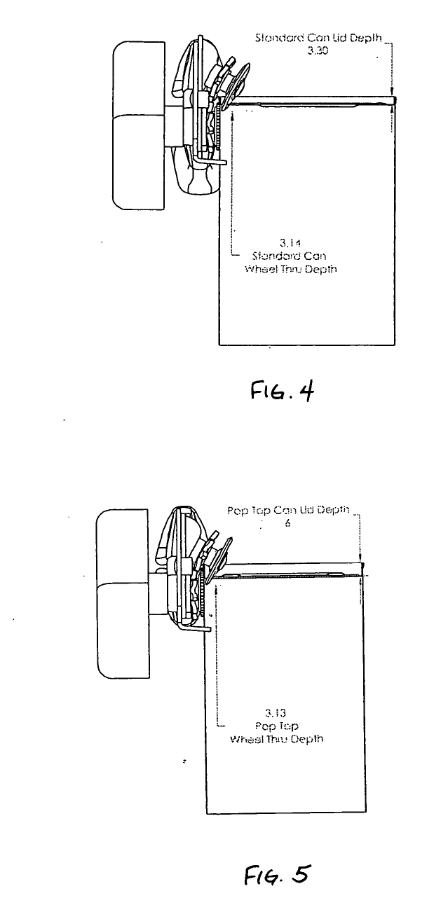

Referring again to FIG. 2, slider assembly 90 has a slider 20 and a tab 23. Slider 20 further has a first cam surface 111 and a spacer means 110. Spacer means 110 provides a second cam surface 112 to slider 20. Cam surfaces 111 and 112 engage an upper cam edge 115 of traction support 2. Referring to FIG. 3, slider 20 is movable between a first position (shown in phantom), where first cam surface 111 interacts with upper cam edge 115 of traction support 2 and a second position, where second cam surface 112 interacts with upper cam edge 115 of traction support 2. Thus, when slider 20 is moved to the second position, spacer 110 provides an abutment that limits the degree to which the handle assemblies 50 and 55 may be moved toward a closed position. This degree is represented by a space n. In this manner, the degree to which cutting means assembly 70 may interact with traction assembly 60 is controlled.

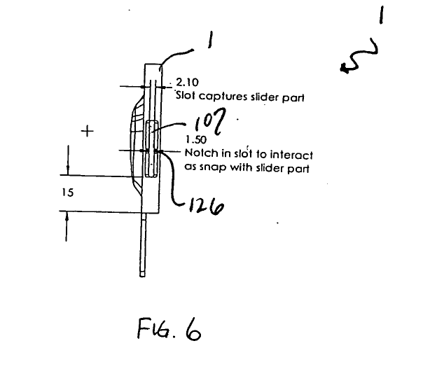

Referring again to FIG. 2, pre-calibration of the can opener 300 is accomplished by spacer means 110 of slider 20. Spacer means 110 provides at least a first cutting position and a second cutting position to can opener 300 by adjusting the distance between handle assemblies 50 and 55 when in the closed or cutting position, thereby adjusting the degree to which traction assembly 60 and cutting assembly 70 can be brought in to overlapping configuration. In this manner, the relative depth of cutting means 7 in relation to a can bead may be adjusted. The depth of a can bead controls the extent to which traction assembly 60 and cutting assembly 70 must be brought in to overlapping configuration, to enable piercing and cutting. Accordingly, can opener 300 is pre-calibrated to be adjustable to fit a bead of a traditional can as illustrated in FIG. 4 as well as the longer bead of a pull-tab type can as illustrated in FIG. 5. The spacer means 110 may be a tab means, cam means, tooth means, varying width means or any other suitable means for providing multiple positions to can opener 300.

As illustrated in FIG. 6, cutting means support 1 preferably has a slider opening 107 for receiving slider assembly 90. Slider opening 107 may further have one or more notches 126 adapted to interact with slider assembly 90. Notches 126 guide slider assembly 90 to one of several pre-calibrated positions in slider opening 107, which correspond to the pre-calibrated heights of cutting means 7. Notches 126 guide slider assembly 90 by means of a friction fit wherein slider assembly 90 may be forced through a first and a second position.

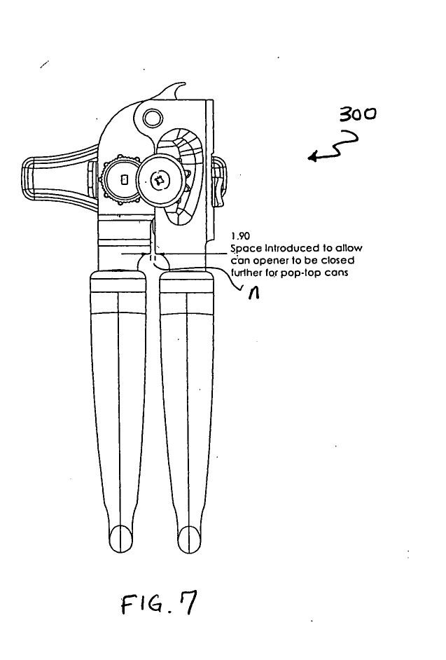

In operation, tab 23 moves slider 20 between at least a first position and a second position in slider opening 107, thereby engaging either of cam surfaces 111 or 112 and upper cam edge 115 of traction support 2. In the first position, spacer 110 of slider 20 does not interfere with the closure of handle assemblies 50 and 55, thereby allowing handle assemblies 50 and 55 to achieve a fully closed position for cutting. In the first position, cutting means 7 has a depth in relation to a can bead sufficient to fit and cut a conventional can bead. When tab 23 is moved to the second position, spacer 110 of slider 20 is moved to the space between handle assemblies 50 and 55, thereby providing an abutment, which interferes with handle assemblies 50 and 55 and prevents closure to the same extent as achieved when tab 23 is in the first position. Thus, as shown in FIG. 7, spacer 110 introduces a gap or space n between handle assemblies 50 and 55. Gap n should correspond to the selected differences in the heights of can beads so that appropriate penetration of a can is achieved in each case. Gap n assumes a first value when first cam surface 111 abuts cam edge 115 of traction support 2. This first value can approach zero. Gap n assumes a second, larger value when second cam edge 112 abuts cam edge 115 of traction support 2. Gap n ensures that cutting means 7 is elevated a prescribed distance, thereby providing a cutting means depth in relation to a can bead sufficient to fit and cut a bead of a pull-tab type can. Accordingly, can opener 300 may be adjusted to penetrate cans having at least two different bead depths by moving tab 23 between a first position and a second position.

The present invention has been described with reference to a hand-held type can opener. It should be understood that slider assembly 90 may also be adapted for use with a powered stationary can opener. In this embodiment, a lever functions to move a drive wheel outside and under a can bead, while a cutting means is moved into and around a can lid. It would be evident to those skilled in the art to incorporate slider assembly 90 in a motorized can opener.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A variable position can opener adapted to open cylindrical can containers having beads of varying sizes, comprising:
a pair of handle assemblies connected about a pivot point;
a cutting means for piercing the lid of a can having a bead, said cutting means being coupled to a first handle of said handle assembly pair;
a driving means for gripping said bead of said can and moving along a periphery of said can, said driving means being coupled to a second handle of said handle assembly pair such that when said pair of handle assemblies are gripped together said cutting means and said driving means are correspondingly brought together for applying a piercing force to said can proximate to said bead;
a gear pair, the first gear of said gear pair being coupled to said cutting means, the second gear of said gear pair being coupled to said driving means, said gear pair being adapted to engage said cutting means and said driving means when said pair of handle assemblies are in the closed position;
a turning means coupled to said driving means for moving said driving means and said cutting means along said bead of said can; and
a cam means selectively movable between a plurality of predetermined positions for limiting the degree to which said pair of handle assemblies can be moved towards each other,
wherein said cam means is adapted to adjust said cutting means to a pre-determined depth of penetration through a lid with respect to said container bead.

2. The can opener of claim 1, wherein said cutting means and said driving means are located substantially equidistant from said pivot point to enable said cutting means and said driving means to overlap.

3. The can opener of claim 1, wherein said cam means is a spacer selected from the group consisting of tab means, cam means, tooth means, varying width means and any combination thereof.

4. The can opener of claim 1, wherein said cam means is a spacer for selectively adjusting the maximum extent of pivoting of said handle pair and therefore the extent of overlap of said cutting means and said driving means.

5. The can opener of claim 1, wherein said spacer means provides an abutment between said pair of pivotally connected handle assemblies.

6. The can opener of claim 5, wherein said abutment prevents said pair of pivotally connected handle assemblies from assuming said closed position.

7. The can opener of claim 1, wherein said spacer means further has a tab means adapted to allow a user to engage said spacer means.

8. The can opener of claim 1, wherein said first handle of said handle assembly pair has an opening for receiving said spacer means.

9. The can opener of claim 1, wherein said spacer means is adapted to adjust said cutting means to fit a bead of a conventional can.

10. The can opener of claim 1, wherein said spacer means is adapted to adjust said cutting means to fit a bead of a pull-tab type can.

11. The can opener of claim 1, wherein said turning means is a knob.

12. A variable position hand-held can opener adapted to open cylindrical can containers having beads of varying sizes comprising:
a pair of pivotally connected handle assemblies, said pair of handle assemblies being adapted to provide a force when pivoted toward a closed position;
a rotatable cutting means coupled to a first handle of said handle assembly pair, said cutting means being adapted to pierce a lid of a can having a bead;
a driving means coupled to a second handle of said handle assembly pair, said driving means being adapted to grip the bead of said can;
a gear pair, the first gear of said gear pair being coupled to said rotatable cutting means, the second gear of said gear pair being coupled to said driving means, said gear pair being adapted to engage said rotatable cutting means and said driving means when said pair of handle assemblies are in the closed position;
a turning means coupled to said driving means for moving said driving means and said rotatable cutting means along said bead of said can; and
a spacer means movable between a first position and a second position, said spacer means being adapted to adjust the position of said cutting means with respect to said bead,
wherein when in said first position, said spacer means does not interfere with said closed position of said handle assembly pair, thereby providing a first cutting means height with respect to said bead, and
wherein when in said second position, said spacer means provides an abutment between said handle assembly pair, thereby producing a space n between said handle assembly pair when in said closed position and providing a second cutting means height with respect to said bead.
